(19) United States
(12) Patent Application Publication
(10) Pub. No.: US 2007/0086350 A1
(43) Pub. Date: Apr. 19, 2007

(54) Method, system, and computer program product for providing failure detection with minimal bandwidth usage

(75) Inventors: Marc E. Haberkorn, Raleigh, NC (US); Gennaro A. Cuomo, Durham, NC (US); Thomas R. Gissel, Apex, NC (US); Barton C. Vashaw, Apex, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/249,536

(22) Filed: Oct. 13, 2005

(51) Int. Cl. H04J 3/14

(52) U.S. Cl. 370/242

(57) ABSTRACT

The present invention provides a method, system, and computer program product for failure detection with minimal bandwidth usage. A method for failure detection in a multi-node system in accordance with an embodiment of the present invention includes the steps of associating all connections between a first node and a second node with a last receipt value and a maximum idle value, calculating a difference between the last receipt value and a current time, and establishing a heartbeat connection from the first node to the second node if the difference between the last receipt value and the current time exceeds the maximum idle value. A heartbeat process is then initiated over the heartbeat connection to determine the condition of the second node.

### BACKGROUND OF THE INVENTION

1. Field of the Invention

The present invention generally relates to failure detection, and more specifically relates to a method, system, and computer program product for providing failure detection with minimal bandwidth usage.

2. Related Art

In typical enterprise computer configurations, one tier of computers, such as an application server tier, needs to know when another tier, or any given machine in another tier, such as a database tier, becomes unavailable. One compelling example of this necessity is a database that is holding locks in association with its open TCP/IP connections. When the entity at the other side of a connection becomes unavailable, it is important to recognize this and release the database locks. In order to shorten any possible outage, the failure detection time should be as small as possible, yet the mechanism for doing so should not produce significant interference (e.g., excessive bandwidth usage) with the data flowing between the tiers under normal operating conditions.

One known failure detection methodology involves the use of a dedicated connection to perform standard heartbeating. In this methodology, one connection is always open between two nodes. Probe packets are sent across this connection on a configured interval, regardless of the state of any other connections between the same two nodes. As such, there is a constant usage of bandwidth with each node simply pinging the other for alive/dead status.

Another known failure detection methodology involves the use of TCP “KeepAlive” on a per-connection basis. The main drawback to this approach is that it must be configured on a per-node (i.e., system wide) basis. This means that all applications must use the same timeout values. Another drawback is that it tests connections independent of one another, regardless of whether or not they connect the same computers. In other words, if there are three connections open between nodes A and B, each of those connections sends heartbeats. Each connection, then, must timeout independent of the others, which is inefficient.

### SUMMARY OF THE INVENTION

The present invention provides a method, system, and computer program product for providing failure detection with minimal bandwidth usage.

A first aspect of the present invention is directed to a method for failure detection in a multi-node system, comprising: associating all connections between a first node and a second node with a last receipt value and a maximum idle value; calculating a difference between the last receipt value and a current time; and establishing a heartbeat connection from the first node to the second node if the difference between the last receipt value and the current time exceeds the maximum idle value.

A second aspect of the present invention is directed to a system for failure detection in a multi-node system, comprising: a system for associating all connections between a first node and a second node with a last receipt value and a maximum idle value; a system for calculating a difference between the last receipt value and a current time; and a system for establishing a heartbeat connection from the first node to the second node if the difference between the last receipt value and the current time exceeds the maximum idle value.

A third aspect of the present invention is directed to a program product stored on a computer readable medium for failure detection in a multi-node system, the computer readable medium comprising program code for performing the steps of: associating all connections between a first node and a second node with a last receipt value and a maximum idle value; calculating a difference between the last receipt value and a current time; and establishing a heartbeat connection from the first node to the second node if the difference between the last receipt value and the current time exceeds the maximum idle value.

A fourth method of the present invention is directed to a method for deploying an application for failure detection in a multi-node system, comprising: providing a computer infrastructure being operable to: associate all connections between a first node and a second node with a last receipt value and a maximum idle value; calculate a difference between the last receipt value and a current time; and establish a heartbeat connection from the first node to the second node if the difference between the last receipt value and the current time exceeds the maximum idle value.

A fifth method of the present invention is directed to computer software embodied in a propagated signal for failure detection in a multi-node system, the computer software comprising instructions to cause a computer system to perform the functions of: associating all connections between a first node and a second node with a last receipt value and a maximum idle value; calculating a difference between the last receipt value and a current time; and establishing a heartbeat connection from the first node to the second node if the difference between the last receipt value and the current time exceeds the maximum idle value.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a flow diagram of a failure detection process in accordance with an embodiment of the present invention.

FIG. 2 depicts an illustrative multi-node system including a failure detection system in accordance with an embodiment of the present invention.

FIG. 3 depicts a heartbeating scenario in accordance with an embodiment of the present invention.

FIG. 5 depicts an illustrative computer system for implementing embodiment(s) of the present invention.

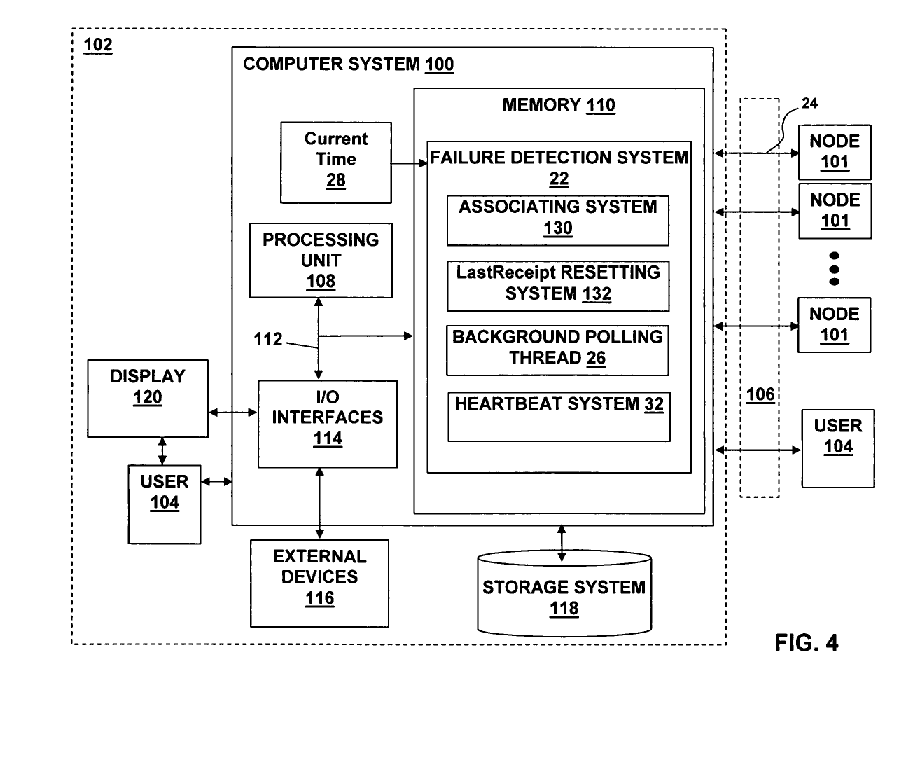

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides a method, system, and computer program product for providing failure detection with minimal bandwidth usage. In particular, the present invention reduces the amount of bandwidth used for the purpose of heartbeating. Instead of using a dedicated heartbeat connection as in the prior art, the present invention monitors all connections to/from a given node for activity. It keeps track of the idle time for the node, and resets that idle time each time a communication occurs with the node. Such communication can comprise data received from or successfully sent to the node or the successful establishment of a connection with the node. Only when this idle time reaches a (user-configured) level does heartbeating begin. At that time, a new connection is opened with the node for the purpose of heartbeating. By assuming that the node can be declared alive by observing activity on just one connection, the present invention eliminates the need (and cost) for continuous heartbeating. The scope of heartbeating can be narrowed from “per node” to “per process” by performing an analysis of created connections to determine process association, and grouping the connections accordingly.

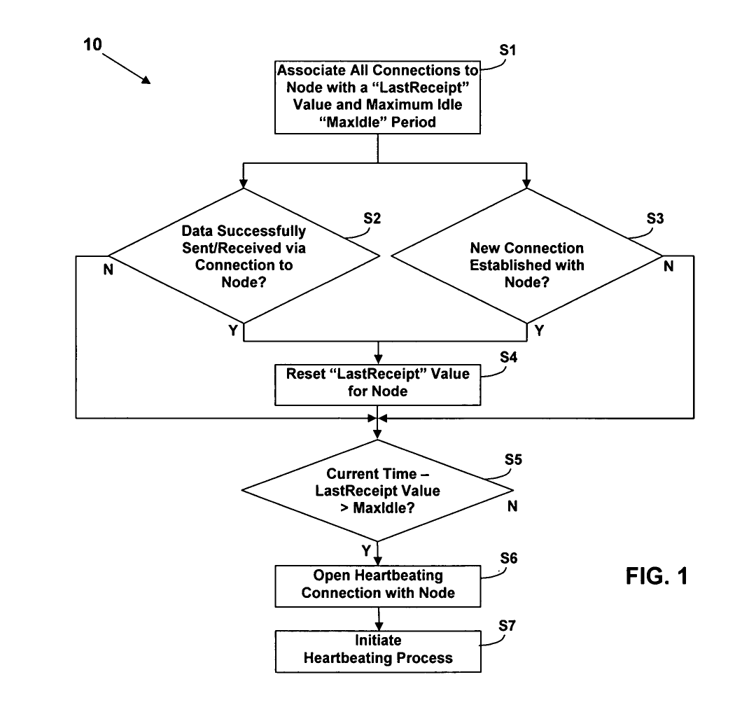

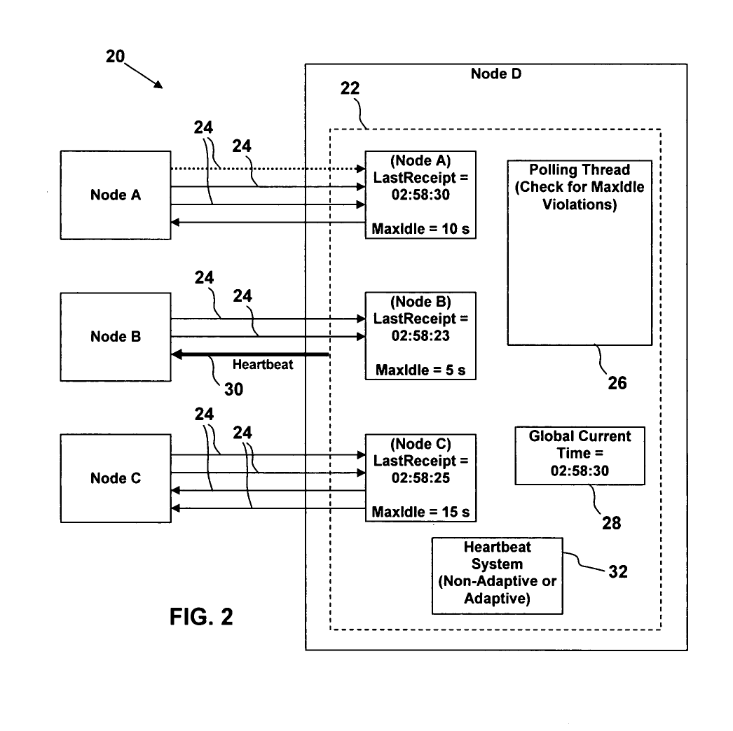

A flow diagram 10 of a failure detection process in accordance with an embodiment of the present invention is illustrated in FIG. 1. The failure detection process will be described with reference to the illustrative multi-node system 20 depicted in FIG. 2. As shown, the multi-node system 20 includes a plurality (four in this example) of nodes Node A, Node B, Node C, Node D. Node D is shown as including a failure detection system 22, although it will be apparent that other nodes in the multi-node system 20 may also include a similar failure detection system 22. In general, such a multi-node system will include any number of nodes and connections between nodes.

In step S1, all connections 24 between two nodes (or processes, if that is the desired granularity) are associated with a “LastReceipt” value and a maximum idle value “MaxIdle.” The MaxIdle value represents the maximum time interval before a failure condition is assumed to have occurred. The MaxIdle value can be configured by a user of the multi-node system 10 or can be determined using any now known or later developed methodology. In FIG. 2, for example, a LastReceipt value of “02:58:30” and a MaxIdle value of “10 s” are associated with the connections 24 between Node D and Node A. Similarly, a LastReceipt value of “02:58:23” and a MaxIdle value of “5 s” are associated with the connections 24 between Node D and Node B, while a LastReceipt value of “02:58:25” and a MaxIdle value of “15 s” are associated with the connections 24 between Node D and Node C. Any time data is successfully received or sent through any of the connections 24 between Node D and one of the other nodes (step S2), or a new connection 24 is successfully created between Node D and one of the other nodes (step S3), the respective “LastReceipt” value associated with that node is reset to the current time 28 in step S4. In FIG. 1, for example, a new connection 24 (dotted line) has been established between Node A and Node D. As such, the “LastReceipt” value associated with Node A has been reset to the current time 28 of “02:58:30.”

The failure detection system 22 includes a background polling thread 26 that runs periodically and checks (step S5) the difference between all LastReceipt values and the current time 28. An illustrative code snippet for implementing the background polling thread 26 may comprise, for example:

while(true){

for each node:
if(CurrentTime − node.LastReceipt > node.MaxIdle)
node.startHeartBeat( )
pause;

}

If the difference value determined by the background polling thread 26 exceeds the MaxIdle value for a given node, a heartbeat connection is opened with the node in step S6 and a heartbeating process is initiated in step S7. In FIG. 2, for example, it can be seen that for Node B the difference value (i.e., 7 s) between the LastReceipt value of “02:58:23” and the current time 28 of “02:58:23” is greater than the MaxIdle time (i.e., 5 s) for Node B. As a result, a heartbeat connection 30 is opened between Node D and Node B and a heartbeat process is initiated by heartbeat system 32 to determine the condition of Node B. Any suitable heartbeat process can be used in accordance with the present invention.

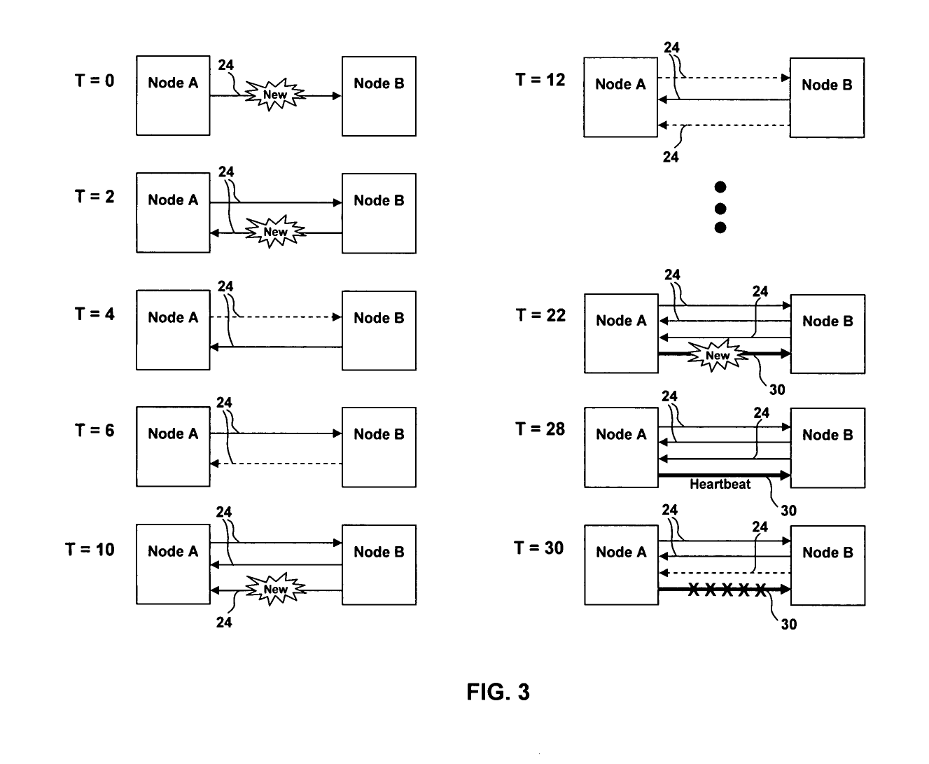

A illustrative scenario illustrating the failure detection process of the present invention is depicted in FIG. 3. In this scenario there are two nodes Node A, Node B.
At time T=0: New connection 24 created from Node A to Node B; Node A knows that Node B is alive.
At time T=2: New connection 24 created from Node B to Node A: Node A knows that Node B is alive.
At time T=4: Data (dashed line) successfully sent from Node A to Node B over a connection 24; Node A knows that Node B is alive.
At time T=6: Data received by Node A from Node B over a connection 24; Node A knows that Node B is alive.
At time T=10: New connection 24 created from Node B to Node A; Node A knows that Node B is alive.
At time T=12: Data successfully sent from Node A to Node B over a connection 24 and Data received by Node A from Node B over a connection 24; Node A knows that Node B is alive.
At time T=22: MaxIdle value of 10 s for Node B is observed by the background polling thread of Node A; Heartbeat connection 30 opened from Node A to Node B.
At time T=28: Heartbeat successfully sent from Node A to Node B; Node A knows that Node B is alive.
At time T=30: Data received by Node A from Node B over a connection 24; Node A knows that Node B is alive and kills heartbeat connection 30.

It can be seen from the above scenario that the failure detection process of the present invention does not require the use of dedicated heartbeat connections between nodes to detect failures. Rather, the failure detection process of the present invention examines the activity occurring on existing connections between nodes to detect failures.

Bandwidth may be further conserved by toggling the length of time between heartbeats once a heartbeat connection 30 is up and running. There are several known methods of performing adaptive heartbeating. One such method monitors the amount of time it takes for a node to acknowledge a heartbeat, and archives a history of these values. From this archive, it can generate a point-in-time probability that a given node has failed. In accordance with the present invention, an additional configuration parameter called maxHeartbeatBandwidth that limits the amount of bandwidth used for heartbeating can be used. Based on this parameter, the maximum heartbeat frequency can be determined. The maximum heartbeat frequency (or a lower frequency) can be used as the initial adaptive heartbeat interval. Then, the heartbeating frequency can be determined in a known manner.

A computer system 100 for providing failure detection with minimal bandwidth usage in accordance with an embodiment of the present invention is depicted in FIG. 4. Computer 100 comprises one of a plurality of nodes 101 in a distributed system. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service for providing failure detection with minimal bandwidth usage in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as failure detection system 22, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 4 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. Such information can include, for example, LastReceipt values, MaxIdle values, etc. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is a failure detection system 22 for providing failure detection with minimal bandwidth usage in accordance with embodiments of the present invention. The failure detection system 22 includes an associating system 130 for associating connections with other nodes 101 with a LastReceipt value and a MaxIdle value, a LastReceipt resetting system 132 for resetting the LastReceipt value of a node 101 if the node is determined to be alive, a background polling thread 26 for calculating the difference between the LastReceipt value of a node 101 and the current time 28 and for a determining MaxIdle violation based on the difference, and a heartbeat system 32 for establishing a heartbeat connection 30 with a node 101 and for performing a heartbeat process (adaptive or non-adaptive) with the node.

The present invention can be offered as a business method on a subscription or fee basis. For example, one or more components of the present invention can be created, maintained, supported, and/or deployed by a service provider that offers the functions described herein for customers. That is, a service provider can be used to provide a service for providing failure detection with minimal bandwidth usage, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for failure detection in a multi-node system, comprising:
associating all connections between a first node and a second node with a last receipt value and a maximum idle value;
calculating a difference between the last receipt value and a current time; and
establishing a heartbeat connection from the first node to the second node if the difference between the last receipt value and the current time exceeds the maximum idle value.

2. The method of claim 1, further comprising:
initiating a heartbeat process over the heartbeat connection to determine a condition of the second node.

3. The method of claim 1, further comprising:
resetting the last receipt value when a communication occurs between the first node and the second node.

4. The method of claim 3, wherein the communication comprises:
data received from or successfully sent to the second node.

5. The method of claim 3, wherein the communication comprises:
a successful establishment of a connection with the second node.

6. Deploying an application for failure detection in a multi-node system, comprising:
providing a computer infrastructure being operable to perform the method of claim 1.

7. Computer software embodied in a propagated signal for failure detection in a multi-node system, the computer software comprising instructions to cause a computer system to perform the method of claim 1.

8. A system for failure detection in a multi-node system, comprising:
a system for associating all connections between a first node and a second node with a last receipt value and a maximum idle value;
a system for calculating a difference between the last receipt value and a current time; and
a system for establishing a heartbeat connection from the first node to the second node if the difference between the last receipt value and the current time exceeds the maximum idle value.

9. The system of claim 8, further comprising:
a system for initiating a heartbeat process over the heartbeat connection to determine a condition of the second node.

10. The system of claim 8, further comprising:
a system for resetting the last receipt value when a communication occurs between the first node and the second node.

11. The system of claim 10, wherein the communication comprises:
data received from or successfully sent to the second node.

12. The system of claim 10, wherein the communication comprises:
a successful establishment of a connection with the second node.

13. A program product stored on a computer readable medium for failure detection in a multi-node system, the computer readable medium comprising program code for performing the steps of:
associating all connections between a first node and a second node with a last receipt value and a maximum idle value;
calculating a difference between the last receipt value and a current time; and
establishing a heartbeat connection from the first node to the second node if the difference between the last receipt value and the current time exceeds the maximum idle value.

14. The program product of claim 13, further comprising:
initiating a heartbeat process over the heartbeat connection to determine a condition of the second node.

15. The program product of claim 13, further comprising:
resetting the last receipt value when a communication occurs between the first node and the second node.

16. The program product of claim 15, wherein the communication comprises:
data received from or successfully sent to the second node.

17. The program product of claim 15, wherein the communication comprises:
a successful establishment of a connection with the second node.
